(19) United States
(12) Patent Application Publication
(10) Pub. No.: US 2005/0226979 A1
(43) Pub. Date: Oct. 13, 2005

(54) Corn degermination machine

(75) Inventor: Peter Matthews, Houston, TX (US)

Correspondence Address: KEELING HUDSON LLC, P.O. BOX 70103, HOUSTON, TX, 77270, US

(73) Assignee: Satake USA, Inc.

(21) Appl. No.: 11/147,872

(22) Filed: Jun. 8, 2005

Related U.S. Application Data
(63) Continuation-in-part of application No. 10/004,742, filed on Dec. 4, 2001, now Pat. No. 6,936,294.

(51) Int. Cl. A23P 1/00

(52) U.S. Cl. 426/483

(57) ABSTRACT

The present invention is an apparatus for degerminaing corn kernels having a tempering chamber for adding moisture to the exposed germ by wetting and soaking the exposed germ; and a germinating chamber to fracture the endosperm about the germ, substantially freeing the germ from the endosperm.

### CROSS-REFERENCE TO RELATED APPLICATIONS

This is a continuation-in-part of U.S. patent application Ser. No. 10/004,742.

### STATEMENT REGARDING FEDERALLY SPONSORED RESEARCH OR DEVELOPMENT

Not Applicable.

### BACKGROUND OF THE INVENTION

1. Field of the Invention

This invention relates generally to corn milling and more particularly to improved machine for degermination of corn.

2. Description of the Related Art

Corn milling processes separate corn into various components of the kernel. In a wet-milling process, the corn is steeped in an aqueous solution to soften the kernel and ground to free the germ. Aqueous processes are described in U.S. Pat. No. 5,073,201 to Gisfeldt et al. In a dry-milling process, the corn kernel is separated into tie endosperm, germ and other fibers (referred to as a hull or bran layer) in a dry or slightly moistened condition.

One of the necessary steps in the dry corn milling process, whether the milled product is to be used for the production of ethanol, starch, flakes, grits or flour, involves separation of the bran and the germ (also referred to as embryo) from the endosperm, which is then processed further to produce the milled corn product.

In a typical dry milling process, corn kernels are cleaned to remove extraneous material. The cleaned corn is tempered with water or steam then passed through a degerminating mill to release the bran from the germ and endosperm.

Traditionally, germ has been removed from corn kernels during milling through the use of a “Beall” type degerminator. In the Beall type of degerminator, corn is fed into and through the annulus formed between a rotating, conical rotor and a stationary concentric screen made of perforated metal. Both rotor and screen are textured with large nodes, which impede motion of the kernels as they turn with the rotor. A weighted discharge plate provides a method of controlling pressure and corn density within the chamber. In this process, the germ is dislodged from the endosperm by impact and bending stress as the kernels move through the annulus. In practice, most of the kernels are broken during the process. Typically, this process produces an effective recovery of endosperm particles of which approximately twenty to thirty percent of the endosperm pieces will be retained on a No. 6 standard sieve cloth. Because a significant portion of the bran may still adhere to the pieces of endosperm after the degermination process, further refinement of the endosperm may be required to reduce the fiber content of the endosperm product.

Inherent inefficiencies in refining and recovery processes result in increased processing costs and a reduction in the overall yield of low fat corn products.

For any of the milled corn products, the production of low fat products is desirable. In general, it is desirable during the degermination stage of the corn milling process to produce large particles of endosperm that are largely free of bran and germ. Though the degermination process can be destructive to the corn kernels, it is generally desirable to minimize the production of fine particles of endosperm, as the fine particles are difficult to separate from the bran and germ particles in order to recover them as a corn product. Maximizing the production of large particles of endosperm thus offers maximum yields of corn products and improves the quality of the products.

U.S. Pat. No. 5,250,313 to Giguere (a continuation-in-part of U.S. Pat. No. 4,189,503) describes a degerminating process wherein the corn kernels are crushed from the thin edges toward the center while avoiding crushing of the relatively flat side surfaces. The crushing force fractures the endosperm under and around the germ and squeezes the germ away from the endosperm. A machine for carrying out the degermination includes relatively rotating discs having corrugations in their facing surfaces in which the kernels are caught and crushed from the thin edges toward the center. An alternative degerminator machine includes a single rotating disc having curved guide vanes on its upper surface for guiding the kernels as they are propelled outwardly by centrifugal force.

U.S. Pat. No. 6,254,914 describes a wet-milling process for recovery of corn coarse fiber (pericarp) including the steps of: soaking corn in water to loosen the attachments of various corn components therein to each other, degerminating the soaked corn to strip the corn coarse fiber and the germ away from the endosperm, recovering the germ, and recovering the corn coarse fiber by flotation. The degerminating step of such process involves grinding the kernels in a degermination mill such as a Bauer mill so that the pericarp and germ are stripped away from the endosperm.

U.S. Pat. No. 4,181,748 to Chwalek, et al. describes a combined dry-wet milling process for refining corn comprising dry milling corn kernels to provide an endosperm fraction, a germ fraction, a fiber (hull) fraction and a cleanings fraction, wet milling the endosperm fraction including using two distinct steeping steps, one upstream and the other downstream of an impact milling step, to provide a mill starch slurry. The process further comprises removing fine fiber tailings from the mill starch slurry, separating the slurry into a starch-rich fraction and protein-rich fraction, concentrating the protein-rich fraction, directly combining the fiber (hull), cleanings, fine fiber tailings and protein-rich concentrate without removing corn oil therefrom, with the germ fraction to provide a wet animal feed product, and drying the feed product.

U.S. Pat. No. 4,301,183 to Giesfeldt et al. discloses a method and apparatus for degerminating a corn kernel by impelling the kernels along a guide vane into an impact surface including a horizontal disc having a plurality of guide vanes extending in a curvilinear path with each vane terminating in an end portion that is substantially parallel to a tangent to the disc. A plurality of impact surfaces are provided in the same horizontal plane as the disc with each surface being substantially linear and extending transversely of the path of travel of a kernel impelled by the disc.

The prior art processes result in a high percentage of fine particles of endosperm that are difficult to separate from the bran and germ particles in order to recover them as a corn product.

Cylindrical, rubberized rollers have been used to remove hulls from other grains, particularly rice. Rollers for removing hulls from grains are described in U.S. Pat. No. 3,104,692 to Davis et al. dated Sep. 24, 1963, U.S. Pat. No. 4,066,012 to Satake and U.S. Pat. No. 5,678,477 to Satake et al. Despite the use of such rollers for removing hulls from grains and the long-standing need to separate corn germ from endosperm with a minimum amount of fine endosperm particles, the use of rubberized rollers and the process of the present invention have not been previously practiced.

### BRIEF SUMMARY OF THE INVENTION

Accordingly, it is an object of the present invention to provide a machine for increasing the production of large particles of endosperm and germ and thus maximize yields of low-fat corn products and improve the value of the products.

The present invention includes an apparatus for tempering corn kernels in a chamber for adding an amount of moisture to the germ by wetting and soaking the exposed germ and a degermination chamber to fracture the endosperm about the germ, substantially freeing the germ from the endosperm while maintaining large particle of endosperm and germ.

### BRIEF DESCRIPTION OF THE DRAWINGS

FIG. 1 depicts a schematic diagram of a debranning and degermination process incorporating the machine of the present invention.

FIG. 2 depicts a cross-sectional top view of a corn kernel with the bran in place.

FIG. 3 depicts a front view of a corn kernel with the bran removed.

FIG. 4 depicts a side view of a corn kernel with the bran removed.

FIG. 5. depicts the debranning apparatus.

FIG. 6 depicts the roller portion of the degermination apparatus.

### DETAILED DESCRIPTION OF THE INVENTION

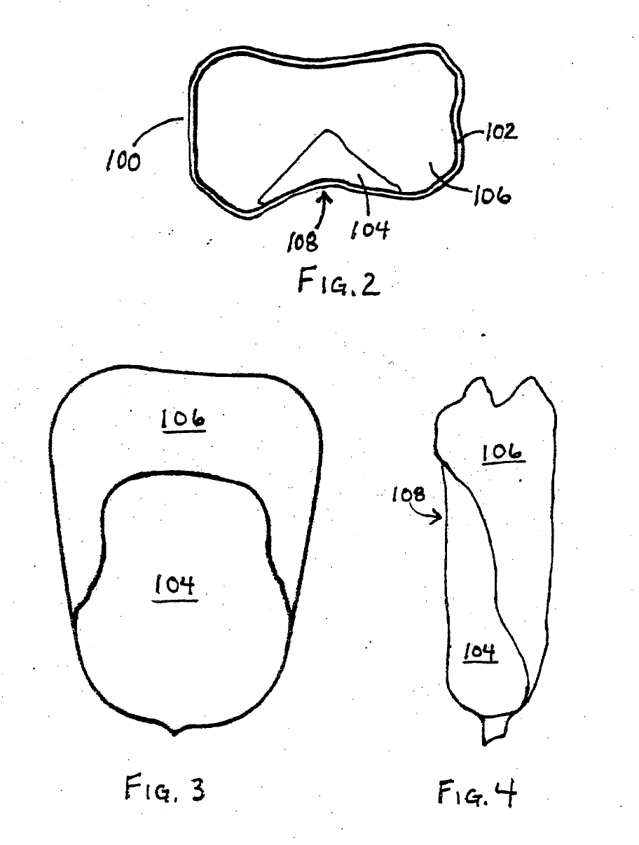

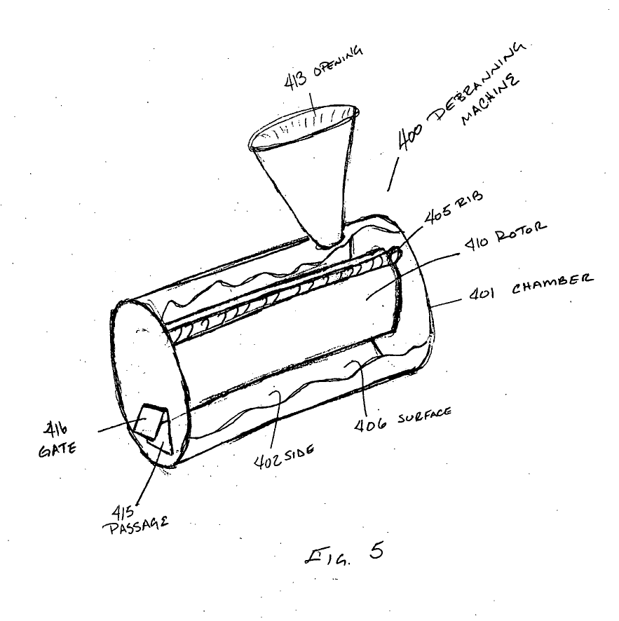

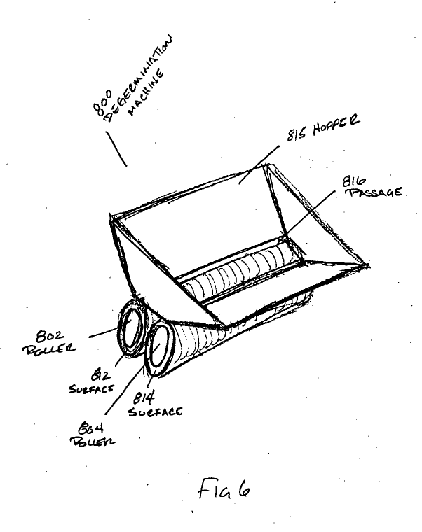

Referring first to FIGS. 2, 3, and 4 a corn kernel 100 is depicted for reference as to terms used herein. A typical corn kernel 100 includes a germ 104 and an endosperm 106 that are totally covered in a casing of bran 102. The germ 104 is embedded in one of the large, relatively flat sides 108 of kernel 100.

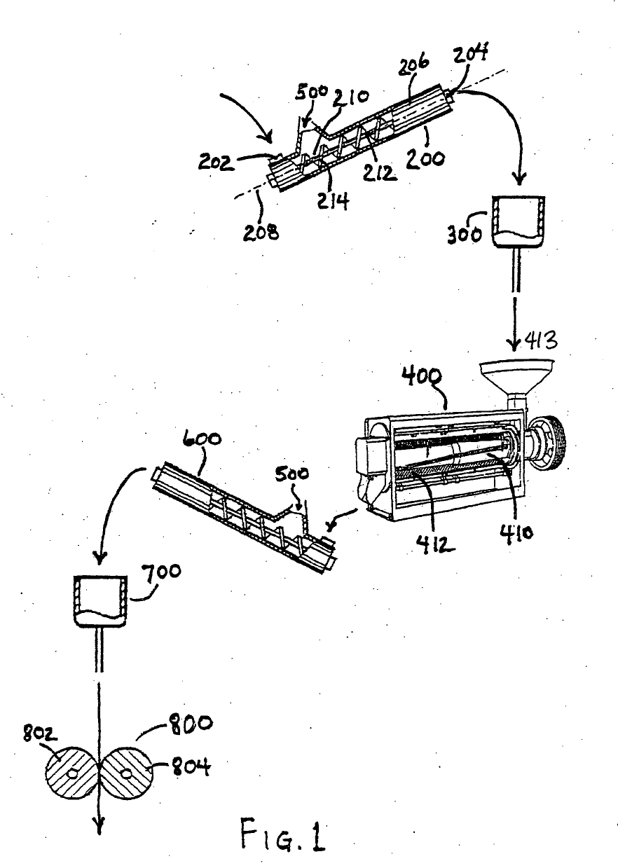

Referring to FIG. 1, the process using the present invention is depicted as a process flow diagram.

In the machine of the present invention the germ of the corn kernels is tempered. A controlled amount of moisture is added to the germ with tempering chamber 600. Within this tempering chamber, moisture swells the germ 104, which absorbs the moisture more quickly that the endosperm 106, and loosens the bond between the germ 104 and the endosperm 106. The holding time may vary depending on the amount of moisture absorption required, but should not be of such duration to permit breaking down of the inter-cellular bonds of the starch of the endosperm 106, as such break down promotes breakage of the endosperm 106.

Referring to FIG. 6, the corn kernels are then fed into the degermination machine 800. In the preferred embodiment, degermination machine 800 includes a tempering apparatus 600, two cylindrical rollers 802 and 804 with a hopper 815 located above cylindrical rollers 802 and 804 and having with a passage 816 at the bottom of hopper 815. Alternatively, degerminating machine 800 may be operable using a plurality of pairs of rollers (not shown). In the preferred embodiment, passage 816 runs the length of rollers 802 and 804 and is sufficiently wide to communicate with rollers 802 and 804 at their upper quadrants where the surface 812 and 814 respectively are moving downward. In alternative embodiment (not shown) passage 816 is sufficiently wide to communicate with one or more rollers. Unlike prior art, cylindrical roller 802 is surrounded by a surface 812 of rubber, polyurethane or other material having suitable elastic properties. Likewise in the preferred embodiment cylindrical roller 804 is surrounded by a surface 814 of rubber, polyurethane or other material having suitable elastic properties. In the preferred surfaces 812 and 814 are of same elastic material. Alternatively (not shown), surface 814 may have an inelastic material having sufficient surface texture to create sufficient friction between rollers 802 and 804 to draw corn kernels from one side of rollers 802 and 804 to the other. The use of two inelastic covered rollers is well-known in the art, as is the large degree of fracturing and large production of small particles of germ and endosperm associated with use of such inelastic coverings. In all embodiments roller at least one surface must be elastic and both surfaces must have a sufficient coefficient of friction to engage the debranned corn kernels 100 while the force applied to the debranned corn kernels by the rollers must be insufficient to substantially crack or crush the debranned corn kernels 100. A stiff rubber or relatively dense polyurethane has been determined to have characteristics consistent with such requirement. In the preferred embodiment having two rollers, the two rollers 802 and 804 rotate in different directions, so the adjacent surfaces move the same direction. In the preferred embodiment, rollers 802 and 804 rotate at different speeds. Because friction mandates that an object in contact with either roller 802 or 804 will attempt to move at the same linear speed as the surface of the roller, a shear force develops across the debranned corn kernel 100, from the difference in linear speed applied to the two different sides of the debranned corn kernel 100. This action causes fracturing of the endosperm 106 about the germ 104, substantially freeing the germ 104 from the endosperm while producing large particles of endosperm 106 and a minimal number of such particles.

At least one of the rollers 802 or 804 is adjustable in relationship to the other so that the friction applied between the roller surfaces may be adjusted to provide sufficient friction to various size corn kernels to fracture endosperm 106, substantially free germ 104, but to avoid pulverizing the kernel 100.

The adjustability of inter-roller friction may be accomplished by varying the differential tangential velocity of the rollers, varying the gap between the rollers, tensioning the distance between the rollers with springs, pneumatic pistons or other tensioning device. Interactive assessment of the applied friction may be accomplished by monitoring the amperage drain of the roller motors, the air pressure in a pneumatic piston, the amperage of the air pressure production pump feeding the pneumatic piston, or other means.

In practice, the application of such friction will result in fracturing endosperm 106 about germ 104, and in tearing of the endosperm 106, resulting in endosperm 106 particles. By minimizing the production of fine particles and by maximizing the size of particles produced, the highest value of the kernel may be realized. Endosperm 106 particles produced as a result of process of the present invention tend to be relatively large as such particles are produced as a result of a shear force rather than an impact force.

Germ 104 maintained in its whole state provides greater oil production. Endosperm 106 maintained in large particle state is suitable for high value end-product uses.

The resulting mixture of germ 104 and endosperm 106 may be separated by various methods known in the art.

1. A machine for degerminating corn kernels, comprising:
a tempering chamber, said tempering chamber being in fluid communication with a fluid supply,
said first chamber being in communication with a supply of said corn kernels;
a degerminating chamber, said degermininating chamber in communication with said tempering chamber, said degerminating chamber having at least one pair of spaced-apart counter-rotating rollers,
said rollers of said at least one pair of spaced-apart counter-rotating rollers having a surface with a sufficient co-efficient of friction to draw said corn kernel from one side of said at least two spaced-apart counter-rotating rollers to the other side of said at least two spaced-apart counter-rotating rollers, said at least two spaced-apart counter-rotating rollers spaced less than one corn kernel thickness apart;
at least one of said rollers of said at least one pair of spaced-apart counter-rotating rollers having an elastic surface
an output chamber, said output chamber communicating with said degerminating chamber.

2. The machine for degerminating corn kernels of claim 1 wherein said elastic surface comprises a rubber surface.

3. The machine for degerminating corn kernels of claim 2 wherein said surface comprising a polyurethane surface.

4. The machine for degerminating corn kernels of claim 3 wherein said opposing rotating cylinders operable at differing tangential velocities.

5. The machine for degerminating corn kernels of claim 5 wherein: at least one of said pair of said opposing rotating cylinders adjustable in relation to the other said opposing rotating cylinder for adjustment of the friction forces applied to said corn kernels.
